(19) United States
(12) Patent Application Publication
(10) Pub. No.: US 2014/0312035 A1
(43) Pub. Date: Oct. 23, 2014

(54) Means, method and process of condensing discarded recyclable cups inside each other

(71) Applicants: Thomas Jon McGuigan, Evanston, IL (US); Julie Ann Smit, Evanston, IL (US)

(72) Inventors: Thomas Jon McGuigan, Evanston, IL (US); Julie Ann Smit, Evanston, IL (US)

(21) Appl. No.: 13/986,333

(22) Filed: Apr. 22, 2013

(51) Int. Cl. B65F 1/00

(52) U.S. Cl. CPC B65F 1/0053; B65F 2210/183
USPC 220/23.83

(57) ABSTRACT

Recycle bins and recycle attachments for stacking and condensing discarded paper cups and plastic glasses inside each other. The process of stacking cups and glasses in a series will greatly increase the available space within recycle bins by eliminating the “wasted empty space” void typically found within empty cups and glasses. Accordingly, recyclable containers will need to be emptied less often which ultimately saves municipalities time, money and maintenance. Additionally, this invention greatly aids in the later sorting and processing of recyclables.

### BACKGROUND INFORMATION

1. Field

The present disclosure relates generally to trash containers for disposing of recyclable waste products. Still more particularly, the present disclosure relates to a tubular cylinder attachment incorporated through the lid of a recycle container for stacking and, thereby, condensing discarded recyclable paper cups and plastic glasses inside each other. This apparatus and method for stacking and condensing discarded paper cups and plastic glasses will more than double the available space within recycle containers. Other embodiments of this invention, also, utilize this cup stacking concept to save space inside recycle bins, as well as, to later help in the sorting and processing of recyclables.

2. Background

The U.S. population produces 100 million tons of paper and plastic waste each year. Much of this recyclable waste is in the form of plastic, paper and Styrofoam cups and glasses produced by fast food restaurants, coffee shops, convenience stores, gas stations, amusement parks, schools, street and music festivals, shopping malls, business cafeterias and so on.

Typically, when people are done with their beverage, they usually throw it into an ordinary trash can. Sometimes people do the environmentally conscientious thing and dispose of their paper or plastic cup or glass in a recycle bin, but only if the establishment provides one.

The problem with both these scenarios is that they do not adequately address or solve the growing recyclable waste problem in this country and for different reasons.

To throw recyclable waste into an ordinary garbage can is not an environmentally responsible solution as the landfills are already overflowing with our garbage. The conscientious and responsible solution to the growing waste problem is to utilize recyclable waste containers so that these valuable resources may be processed and reused and not just dumped into the landfills.

Most communities are in fact turning to “Green” technology to help eliminate the wastefulness of our resources and are providing special containers for recyclable waste so it may be kept separate from the actual garbage. However, a big problem with the standard recycle containers is that they fill up extremely quickly as much of the container comprises paper and plastic glasses and cups which contain “empty wasted space” within them.

For example, in Evanston, Ill. outside the highly popular local coffee shop, a recycle container is provided by the city and is at times overflowing onto the street with coffee cups and plastic glasses. This particular recycle bin fills up very quickly due to the large volume of cups and glasses being disposed of and the “empty wasted space” inside them.

Accordingly, the standard recycle bin needs to be redesigned to better utilize the available space inside the recycle container.

This will allow more recyclable waste to be thrown into the can and accordingly, the recycle bins won't need to be emptied as often.

The prior art in recyclable trash cans has attempted to address this “empty wasted space” issue by utilizing containers which try to compress the bulky plastic glasses and paper cups. These compressing trash cans are run by solar powered batteries, and do not function very well as much more pressure is needed for compression than is supplied by a solar powered battery. Also, on a cloudy day, they fail to function properly.

Consequently, the problem with the above recycle bins and bin “solutions” is they don't work very well, if at all, at freeing up the available space within these recycle bins.

The present invention provides an extremely simple and cost effective method and solution for eliminating the “empty wasted space” issue. In general, this invention stacks and condenses discarded paper cups and plastic glasses, in their manufactured state, all inside each other, thereby, eliminating the wasted void within the empty cups and glasses. The process of stacking cups and glasses in a series greatly increases the available space within the recycle bins.

### SUMMARY

The disclosed invention provides new and unique recycle bins, methods and attachments for stacking and condensing recyclable cups and glasses all within each other.

In one embodiment, the cups and glasses are stacked by inserting them bottom side down into a piece of plastic p.v.c. pipe and pushing down. The p.v.c. pipe is approx. 4½ inches in diameter and 8 inches in length. Approximately, 6 inches of the pipe extends at a slight angle outward from the top surface of the recycle bin's lid and the remaining 2 inches continues at a slight angle downward towards the inside center of the recycle bin. This design enables the p.v.c. pipe to be fastened to the underside of the recycle bin's lid with a simple “L” bracket.

The very bottom end of the p.v.c. pipe within the recycle bin contains a V-shaped rubber flange piece over the bottom opening. The V-shaped rubber flange piece holds the cups taught and positions them to be stacked and condensed one inside the other. Once a varying number of cups are stacked in series inside the p.v.c. pipe, the pushing pressure from the condensed cups causes the entire stack to begin to push through the rubber flange piece.

In operation, as more and more cups are pushed into the pipe, this causes clusters of the stacked cups to break apart, due to their weight, from the main condensed series and drop down into the recycle bin. The number of condensed cups in series varies due to cup size, etc. Typically, approximately 5 cups are condensed together before the stacked series drops down into the recycle bin.

The tubular attachment is only for condensing recyclable cups and glasses. A separate large opening may be provided in the center of the recycle lid for disposing of other recyclables such as newspapers, bags, plates, drink lids, etc.

An alternate embodiment for the recycle bin's lid design contains an approximate 2 inch by 4 inch slot in the top center of the recycle bin's lid. This slot is for disposal of beverage lids only. This way the entire recycle bin is allocated solely for paper cups, plastic glasses and their lids and will be marked, “CUPS ONLY”. This bin will be lined with a recyclable garbage bag marked with the recyclable logo. The benefit of this embodiment is that when the bag is removed from the bin it will contain completely pre-sorted recyclables. This feature will greatly aid municipalities in the sorting and recycling process.

Still another embodiment utilizes an elongated tube, in lieu of a bin, for stacking and disposing of cups, glasses and their lids only. The cup stacker embodiment is advantageous when large numbers of recyclable cups and glasses need to be disposed of in a convenient, efficient manner. The cup stackers may be attached to outdoor poles, for example, at summer festivals, parks, amusement parks, outdoor coffee shops, etc. anywhere that large numbers of recyclable cups and glasses are the primary trash component. The elongated tube may vary in overall length to accommodate space restrictions.

### BRIEF DESCRIPTION OF THE DRAWINGS

The nature of the preferred embodiments may be understood best from a study of the attached drawings, wherein:

FIG. 1 is an illustration showing an ordinary recycle/trash can full of cups and glasses exemplifying the “wasted empty space” problem;

FIG. 2 is a diagram showing one embodiment for a recyclable bin which condenses cups and glasses inside each other;

FIG. 3 illustrates how the recyclable bin's cup condenser works;

FIG. 4 is a diagram of an alternate embodiment for recycle bin's lid which contains a slot for disposal of beverage lids;

FIG. 5 schematically shows the V-shaped flange piece on the bottom of the cup condenser;

FIG. 6 shows an alternate flange design which more solidly holds and condenses cups and glasses;

FIG. 7 is an alternate embodiment for a recycling bin utilizing two cup condensers;

FIG. 8 is a diagram utilizing elongated, recyclable tubes for stacking paper cups and plastic glasses in a series;

FIG. 9 shows how an elongated cup stacking tube can be attached and used on the exterior of a recycle bin or trash can;

FIG. 10 shows an alternate cup stacking tube with a slot for disposal of beverage lids;

FIG. 11 shows a cup stacking tube with a flared top diameter for easier insertion of cups and glasses; and

FIG. 12 illustrates how two or more cup stacking tubes may be used for different cup sizes.

### DETAILED DESCRIPTION

In greater detail, FIG. 1 is an illustration showing a standard recycle container 10 with cups 12 and glasses 14 illustrating the “wasted empty space” problem 16 within standard recycle container 10. Standard recycle container 10 is presently being used all over the country. As illustrated, standard recycle container 10 fills up quickly and needs to be emptied on a daily basis (often even multiple times a day), which additionally, adds to its cost and maintenance program.

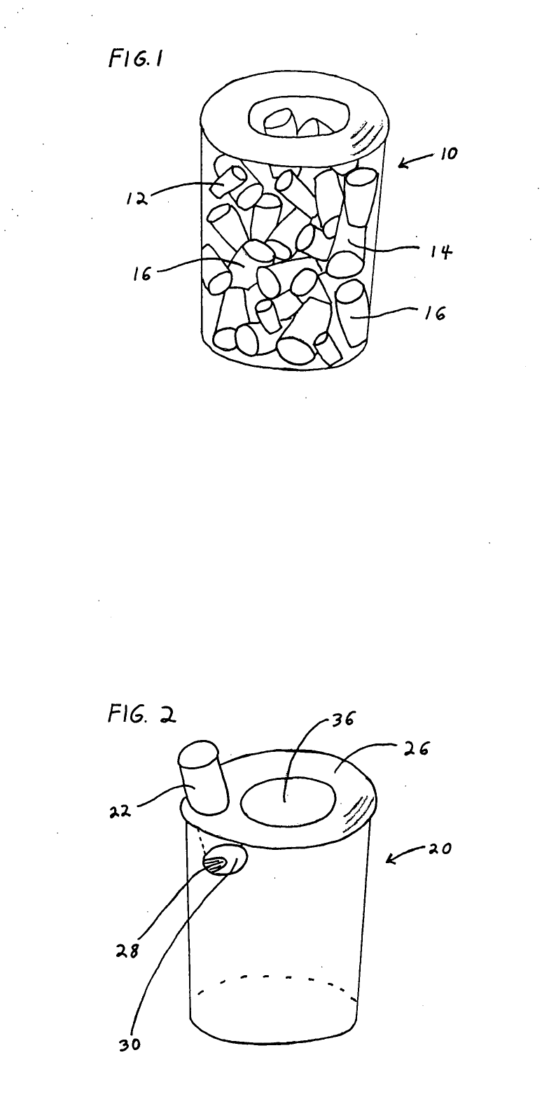

FIG. 2 shows a preferred embodiment for a recycle bin 20 which contains a cup condenser 22. Cup condenser 22 extends outward at a slight angle from the top of recycle lid 26. Cup condenser 22 may be made from a piece of plastic p.v.c. pipe which is roughly eight inches in length and has a 4½ inch wide inside diameter.

Referring to FIG. 2, approximately six inches of the cup condenser 22 extends outwardly from the top of recycle lid 26, while the other two inches of cup condenser 22 is located beneath recycle lid 26.

Cup condenser 22 contains a V-shaped rubber flange 28 over the bottom opening 30 of cup condenser 22. The V-shaped rubber flange 28 holds the cups and positions them to be stacked and condensed one inside the other. The V-shaped rubber flange 28 is fabricated from a fairly stiff piece of rubber in order to hold and position the cups for the condensing process.

Cup condenser 22 is only for recyclable cups and glasses. A separate, large opening 36 may be located in the center of the recycle lid 26 for disposing of other recyclables such as newspapers, bags, plates, drink lids, etc.

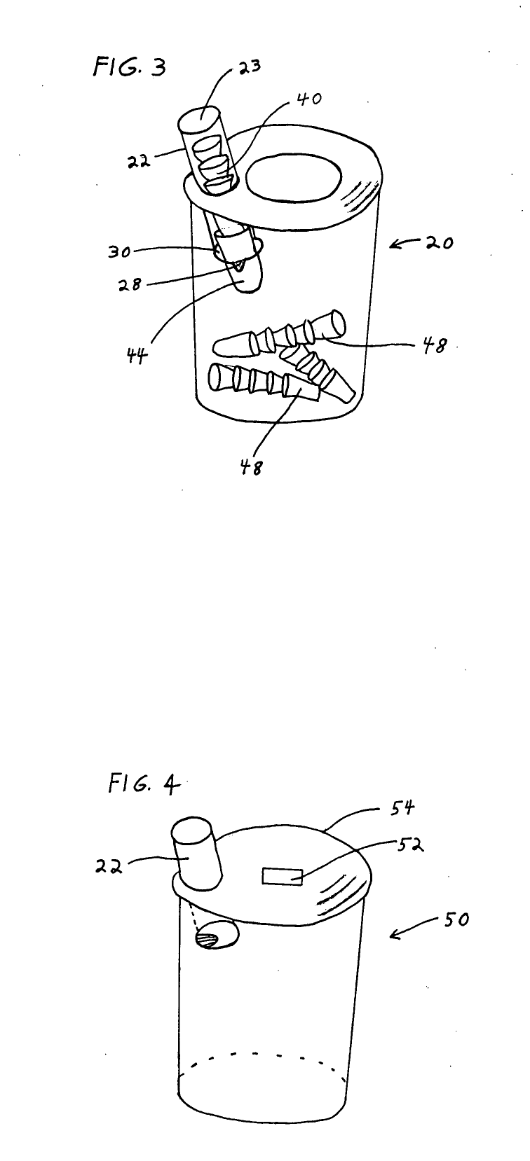

FIG. 3 is an illustration showing how cup condenser 22 functions.

In greater detail, cups 40 are placed into cup condenser 22 through an opening 23. Cup condenser 22 has an approximate 4½ inch wide inner diameter so that opening 23 will accommodate all cup and glass sizes from small to jumbo. As the basic measurements of all recyclable cups and glasses are narrow at the bottom and flared at the top, this allows all sizes to be stacked within each other. In other words, just as new cups and glasses come packaged in a stacked mode to save space, their disposal can be accomplished in a like manner to help save space inside the recycle containers.

An added benefit of the stacking process is that it later helps municipalities in the sorting and processing of like recyclables.

In operation, once approximately five cups 40 are stacked in series inside cup condenser 22, the insertion pressure from the sixth cup 40 will cause the entire stack 44 to begin to push through the V-shaped rubber flange 28. As more and more cups 40 are pushed into cup condenser 22 and out through V-shaped rubber flange 28, the lack of support and downward weight causes clusters of the stacked cups 48 to break apart from the main condensed series and drop down into the recycle bin 20.

FIG. 4 shows an alternate recycle bin 50 which incorporates a slot 52 for disposal of beverage lids. Slot 52 may measure approximately 2 inches by 4 inches and may be located in the top center of the recycle bin's lid 54. Recycle bin 50 containing slot 52 enables the cup condenser 22 to function at its full condensing potential as no other recyclables, such as newspapers, etc. will fit through slot 52 and potentially block the condenser shoot.

Accordingly, recycle bin 50 will be designated solely for paper and plastic cups and glasses and their lids and will be marked such.

In operation, recycle bin 50 is lined with a garbage bag with the recycle logo. Once recycle bin 50 is full of cups, glasses and lids, recycle bin's lid 54 is removed and the entire garbage bag full of like pre-sorted recyclables is ready for processing.

Alternately, two recycle bins 50's could be used. One recycle bin 50 designated solely for paper cups while the other recycle bin 50 is designated solely for plastic glasses. Even a container for catching beverage lids could be provided beneath slot 52 in order to further separate the lids from the cups and glasses.

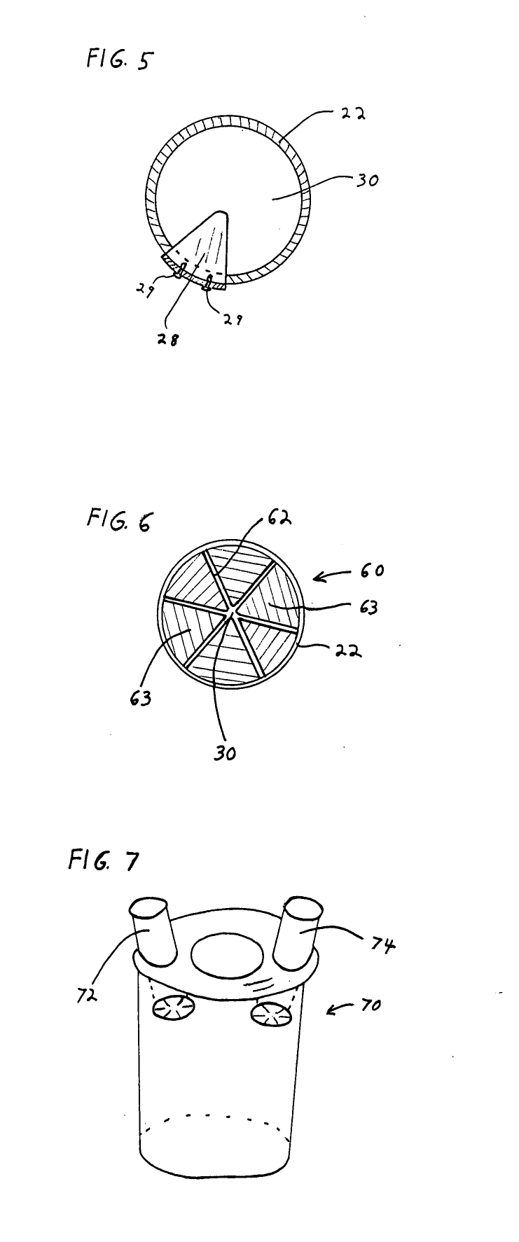

FIG. 5 is a diagram of V-shaped rubber flange 28 over the bottom opening 30 of cup condenser 22. The V-shaped rubber flange 28 holds the cups taught and forces them to be stacked and condensed one inside the other. As previously stated, V-shaped rubber flange 28 is fabricated from a fairly stiff piece of retractable rubber in order to hold and position the cups for the condensing process. V-shaped rubber flange may be fastened to cup condenser 22 with screws 29 or any other securing or bonding method.

FIG. 6 shows an alternative design for a flange. In greater detail, a slit rubber flange 60 is attached over the bottom opening 30 of cup condenser 22. Approximately, six slits 62 are cut through the rubber membrane in order to form flaps 63. These flaps 63 are fabricated from a fairly stiff piece of retractable rubber in order to hold the cups taught which allows them to be stacked and condensed one inside the other.

In operation, as cups are dispelled through bottom opening 30 in cup condenser 22, these flaps 63 form a more solid grip on the cups. This stronger grip continues to hold and, thereby, condense the new cups as they are inserted. Accordingly, slit rubber flange 60 causes more cups and glasses to condense together in series.

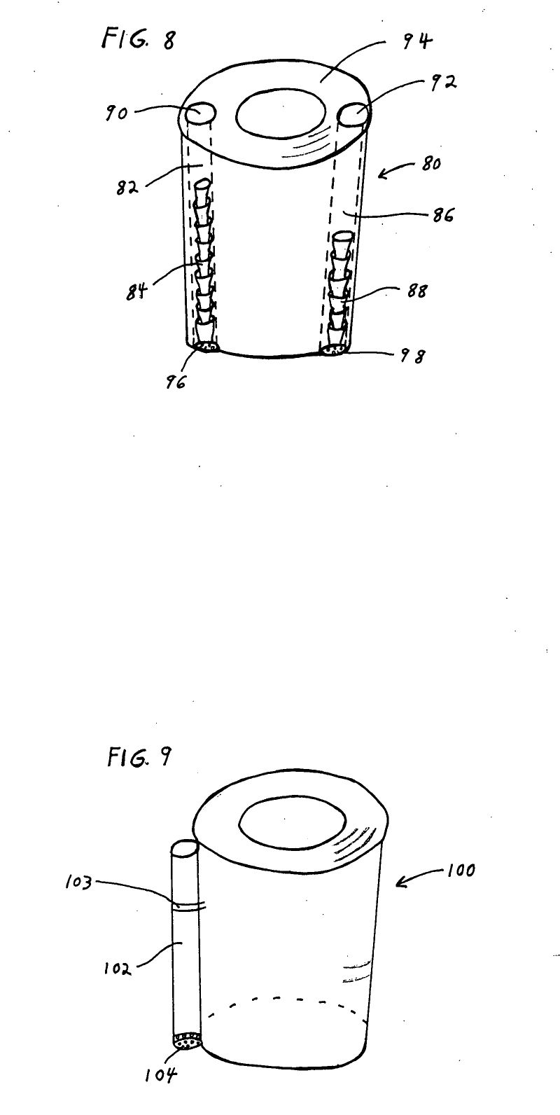

FIG. 7 shows an alternate recycle bin 70 which includes two cup condensers 72 and 74. Cup condenser 72 may be for stacking and condensing paper cups while cup condenser 74 may be for stacking and condensing plastic glasses. This embodiment aids municipalities in the later processing and sorting of recyclable papers and plastics.

In operation, paper cups alone will be inserted through cup condenser 72 while plastic glasses alone will be inserted through cup condenser 74. The paper and plastic cup condensers will be marked accordingly. The end result will be like materials stacked together in series within recycle bin 70.

FIG. 8 is an illustration of a different variation for a recycle container. Here recycle container 80 utilizes two elongated, recyclable tubes one for stacking paper cups 84 and the other for stacking plastic glasses 88.

Paper cup stacker 82 may be made from a recyclable cardboard tube and when removed, recycled along with the paper cups 84 it contains. The plastic glass stacker 86 may be made from recyclable plastic tube and when removed, recycled along with the plastic glasses 88 it contains.

Both paper cup stacker 82 and plastic glass stacker 86 comprise elongated tubes which run the entire height of recycle container 80 and which may measure approximately 3 feet.

Lid 94 of recycle container 80 contains two openings 90 and 92 which hold cup stacker 82 and glass stacker 86 in position. Perforations 96, 98 may be placed through the bottom of cup stacker 82 and glass stacker 86 for drainage of spilled beverages as well as weather-related elements when used outdoors.

In operation, when cup/glass stackers 82 and 86 are full, they are simply pulled out from openings 90 and 92 and conveniently disposed of in the recycle truck—cup and glass stackers, cups and glasses and all. The maintenance person will then simply insert new recyclable cup and glass stackers 82 and 86.

Alternately, cups condensers 82 and 86 could be made from a long piece of p.v.c. pipe and simply emptied and reinserted back into recycle container 80.

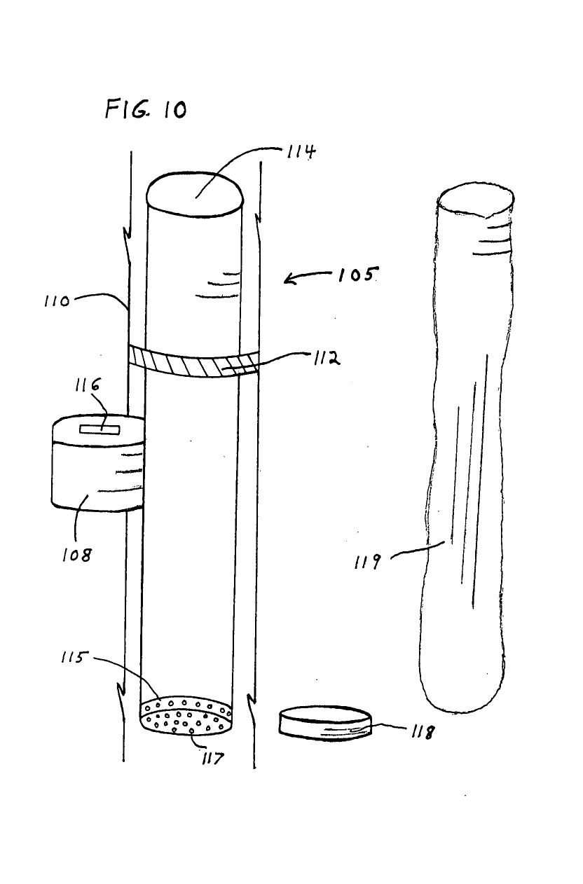

FIG. 9 shows a cup stacking tube 102 attached to the outside of a recycle bin 100 or even a standard trash can. Cup stacking tube 102 may be utilized anywhere an abundance of recyclable cups and glasses needs to be disposed of, for example in a coffee shop, outside of a coffee shop, or outdoor beer/wine garden or festival. Perforations 104 in the bottom may be provided for drainage especially in outdoor locations. A bracket 103 or other means for removably securing the cup stacking tube 102 is provided.

FIG. 10 shows an alternate cup stacking tube 105 which utilizes a compact container 108 for disposal of beverage lids. In operation, cup stacker 105 may be fastened to anything inside or outdoors. For example, an outdoor pole 110 at a street fair, outdoor coffee shop, park, etc. by attaching it with bracket 112 or other securing means. Empty cups are inserted and disposed of through opening 114 and their lids are inserted and disposed of through slot 116. Perforations 117 are provided for drainage in removable cap 115. An alternate solid cap 118 may be provided to seal the bottom of cup stacking tube 105 when used inside.

Additionally, a plastic recycle bag 119 may be used to line the interior of cup stacking tube 105 and be recycled along with the cups and glasses it contains.

Additionally, any of the rubber flange mechanisms may be added to the interior of cup stacking tube 105, if desired, and then cup stacking tube 105 would be used without recycle bag 119.

FIG. 11 shows a cup stacking tube 120 which comprises a flared rim 122 for easier cup insertion. The slit rubber flange 124 may be incorporated into cup stacking tube 120 to capture, position and condense cups 126 with added stability. Cup stacking tube 120 may run the entire length of a recycle bin and be used either on the interior or exterior of the recycle container or even by itself by securing it with a clip 129, bracket or other means to a wall, pole, counter, etc.

A removable cap 132 may be provided to seal the bottom of cup stacking tube 120 when used in indoor locations and a perforated cap 134 for outdoor use.

Additionally, a sensor 130 may be added to cup stacking tube 120 or any of the disclosed embodiments to activate a voice, “thank you” each time a cup or glass is inserted. This will encourage kids as well as adults to do the environmentally responsible action for our planet as well as future generations.

Additionally, the flared rim 122 disclosed in FIG. 11 may be used on any of the cup condensers or cup stacking tubes disclosed in this application

All embodiments of the cup stacking tubes may measure approximately 3 feet or more in height and contain a 4½ inch inner diameter which dimension accommodates all cup widths from small, of course, to jumbo. However, let it be specifically understood that all cup condensers and cup stacking tubes can be any length and width depending upon location used, dimensions of any container it is affixed to or through, cup and glass dimensions, use or non use of garbage bag liners, etc.

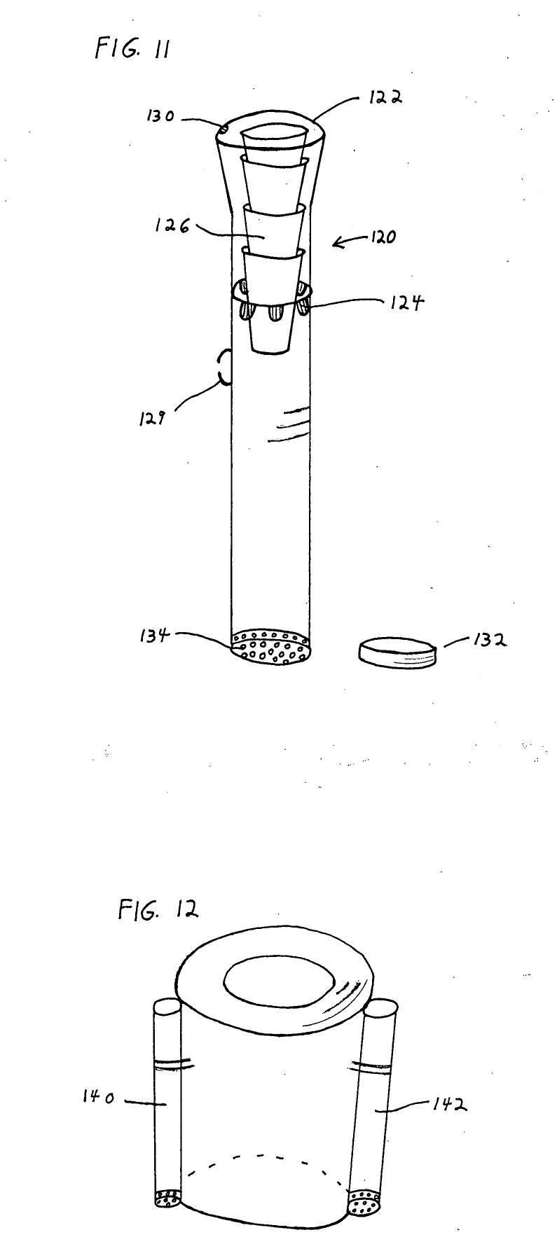

FIG. 12 illustrates how several cup stacking tubes could be used together or in close proximity to each other and designated for disposal of various sized cups and glasses. For example, one cup stacking tube 140 would be designated for small and medium sized drinks while cup stacking tube 142 would be designated for large and jumbo sized drinks. This way the cups would fit together even more compactly as they are stacking basically the same size cup. The beverage lids would be disposed of in any of the containers or bins disclosed herein.

In operation, all recycle bins and stacking tubes disclosed in this application can be easily emptied of recyclables. All embodiments disclosed have removable lids and caps for easy access to discarded cups and glasses. Furthermore, it will be easy for workers to know when the containers are full because the cups or glasses will begin to extend, in a stacked form, from the top of the tubes. Workers need no longer open the lids of recycle bins to view their fullness.

Those skilled in the art will readily perceive other changes and modifications which may be made in the inventive structures and perceive new and different uses for the inventive structures. For example, all components of the disclosed recycle bins, cup condensers and elongated tubes may be interchanged with each other and substituted for each other without departing from this invention.

Furthermore, all cup condensers and cup stacking tubes can be any length and width depending upon the area or location they are used, dimensions of any containers they are affixed to or through; dimensions especially widths of various sized cups and glasses; use of garbage bag liners, etc.

Additionally, all cup condensers and cup stacking tubes can be used for disposal of non-recyclable cups and glasses when conserving space and less maintenance of emptying trash containers is the primary goal.

Therefore, the appended claims are to be construed broadly enough to cover all equivalent structures falling within the scope and spirit of this invention.

We claim:

1. A tubular apparatus for disposing and stacking of recyclable cups and glasses; wherein said recyclable cups and glasses are stacked one inside the other in order to reduce the wasted space void within said recyclable cups and glasses, whereby the process of disposing and stacking of said recyclable cups and glasses into said tubular apparatus will better utilize the available space inside a recycle container.

2. The tubular apparatus of claim 1 wherein said tubular apparatus comprises a tubular cylinder attachment incorporated through the lid of a recycle container for inserting and disposing of recyclable cups and glasses, whereby said recyclable cups and glasses may be stacked inside each other in order to increase the available space within said recycle container and, whereby said process of stacking like recyclables later helps municipalities in the sorting and processing of recyclables.

3. The recycle lid of claim 2 wherein said recycle lid includes an opening for other disposable recyclables such as newspapers, beverage lids, etc.

4. The recycle lid of claim 2 wherein said recycle lid includes a slot for disposal of beverage lids.

5. The tubular cylinder attachment of claim 2 wherein a flange mechanism is incorporated into said tubular cylinder attachment to catch and condense said recyclable cups and glasses.

6. The tubular cylinder attachment of claim 2 wherein said tubular cylinder attachment is formed from a piece of plastic pipe.

7. The tubular cylinder attachment of claim 2 wherein two or more of said tubular cylinder attachments are incorporated through said recycle lid.

8. The tubular cylinder attachment of claim 2 wherein said tubular cylinder attachment includes a sensor to respond with a voice greeting when said recyclable cups and glasses are inserted into said tubular cylinder attachment.

9. The tubular cylinder attachment of claim 2 whereby the top of said tubular cylinder attachment comprises a flared rim for easier insertion of said recyclable cups and glasses.

10. The tubular apparatus of claim 1 wherein said tubular apparatus comprises an elongated tubular cylinder for disposing of said recyclable cups and glasses, whereby said recyclable cups and glasses may be stacked inside each other in order to increase the available space within said recycle container; and the length of said elongated tubular cylinder corresponding to the length of said recycle container.

11. The tubular apparatus of claim 1 wherein said tubular apparatus comprises an elongated tubular cylinder for disposing of recyclable cups and glasses, whereby said recyclable cups and glasses may be stacked inside each other in order to increase the available space within said elongated tubular cylinder.

12. The elongated tubular cylinder of claim 11 wherein said elongated tubular cylinder is used in conjunction with a recycle container.

13. The elongated tubular cylinder of claim 11 wherein said elongated tubular cylinder is used without a recycle container.

14. The elongated tubular cylinder of claim 11 wherein two or more of said elongated tubular cylinders may be utilized together.

15. The elongated tubular cylinder of claim 11 wherein said elongated tubular cylinder is fabricated from cardboard.

16. The elongated tubular cylinder of claim 11 wherein said elongated tubular cylinder is fabricated from plastic.

17. The elongated tubular cylinder of claim 11 wherein the bottom end of said elongated tubular cylinder includes a removable cap to seal said bottom end.

18. The removable cap of claim 17 wherein said removable cap contains a multiplicity of openings for drainage.

19. The elongated tubular cylinder of claim 11 wherein said elongated tubular cylinder contains a removable liner for recyclable waste.

20. The elongated tubular cylinder of claim 11 wherein said elongated tubular cylinder contains a flange mechanism to catch and condense said recyclable cups and glasses.

21. The elongated tubular cylinder of claim 11 wherein a container with a slot is provided for disposal of beverage lids.

22. The elongated tubular cylinder of claim 11 which includes a voice sensor to respond with a greeting when said recyclable cups and glasses are inserted into said elongated tubular cylinder.

23. The elongated tubular cylinder of claim 11 which includes a flared rim for easier insertion of said recyclable cups and glasses.

24. The process of using an elongated tube for disposing of empty recyclable cups and glasses, whereby said empty recyclable cups and glasses are inserted through an opening in the top of said elongated tube in order to stack them together in series, said process greatly reducing the empty wasted space void within said empty recyclable cups and glasses.

25. The process of stacking and, thereby, condensing recyclable cups and glasses inside each other in order to better utilize the available space within a recycle container, accordingly said recycle container will not have to be emptied as often, and said stacking process later helping in the sorting and processing of like recyclables.
